(19) United States
(12) Patent Application Publication
(10) Pub. No.: US 2003/0174226 A1
(43) Pub. Date: Sep. 18, 2003

(54) Image sensor capable of controlling reset voltage automatically and control method thereof

(76) Inventors: Hyun-Joo Ahn, Ichon-shi (KR); Chan-Ki Kim, Ichon-shi (KR)

Correspondence Address: BIRCH STEWART KOLASCH & BIRCH, PO BOX 747, FALLS CHURCH, VA, 22040-0747, US

(21) Appl. No.: 10/330,260

(22) Filed: Dec. 30, 2002

(30) Foreign Application Priority Data
Mar. 12, 2002 (KR) 2002-0013115

(51) Int. Cl. H04N 5/335

(52) U.S. Cl. 348/294

(57) ABSTRACT

The present invention provides an image sensor with an improved automatic control of a reset voltage and a control method thereof. The inventive image sensor includes: An image sensor, comprising: a pixel array unit including a plurality of pixels for detecting optical information inputted from an external environment; an analog line buffer unit that detects and stores voltages of the plurality of pixels in a selected row; and an automatic reset voltage clamping unit for adjusting a clamping voltage value in response to a reset voltage distribution of a pixel output before storing the outputted value from the pixel array unit. The method includes the steps of: comparing a reset voltage signal transmitted from a pixel to a present, a maximum and a minimum clamping voltages and outputting a signal of a first or a second level; counting the signals of the first and the second levels; and comparing the counting results for one frame with each other and adjusting the clamping voltage.

### FIELD OF THE INVENTION

The present invention relates to an image sensor; and, more particularly, to an image sensor capable of controlling a reset voltage automatically and a control method thereof.

### DESCRIPTION OF RELATED ARTS

Image sensor is a device that generates an image by using a property of a semiconductor device that reacts to light. That is, it is a device that reads detections captured by a unit pixel of the image sensor, which senses different levels of intensity and wavelengths of various lights emitted from different objects, as electric values. Particularly, it is the function of the image sensor that converts these electric values into a level enabled with a signal processing.

In other words, the image sensor is a semiconductor device that converts an optical image into an electric signal. A charge coupled device (CCD) is a device wherein each metal-oxide-silicon (hereinafter referred as to MOS) capacitor is closely located, and a charge carrier is stored into the MOS capacitor and transferred. A complementary metal oxide semiconductor (hereinafter referred as to CMOS) image sensor is a device that makes MOS transistors as the same number of existing pixels by employing CMOS technology that uses a control circuit and a signal processing circuit as periphery circuits and adopts a switching mode that detects outputs sequentially.

The CMOS image sensor can be usefully applied to a personal portable system such like a cellular phone since it has an advantage of low power dissipation.

Accordingly, the image sensor has further various applications used for PC cameras, medical purposes and toys.

FIG. 1 is a block diagram showing an image sensor in accordance with the present invention.

Referring to FIG. 1, a conventional image sensor includes a pixel array unit 10, a control and external system interface unit 11, an analog line buffer unit 12 and an image signal processing unit 13.

Hereinafter, operational steps of each element constituting the image sensor will be described in more details.

The pixel array unit 10 arrays horizontally N numbers of pixels and vertically M numbers of pixels, where N and M are integers, in order to maximize reactivity to light. The pixel array unit 10 is essential since it detects information on an image provided from an external source. The control and external system interface unit 11 controls an overall operation of the image sensor by using a finite state machine (FSM) and enacts as an interface to the external system. The control and external system interface unit 11 is able to program information related to various internal operations due to a batch register (not shown), and also controls operations of a whole chip in accordance with the programmed information.

The analog line buffer unit 12 detects and stores voltages of pixels in a selected row, and includes various lines to be employed for color interpolations used at a rear end and an image signal processing. The image signal processing unit 13 performs diverse functions to improve functions of the image sensor based on output values of the pixels, e.g., color interpolation, color correction, gamma correction, auto white balance and auto exposure, stored at the analog line buffer unit 12.

Meanwhile, there occurs a fixed pattern noise in the image sensor due to an offset voltage resulted from a micro-difference in fabrication processes. To compensate the fixed pattern noise, the image sensor employs a correlated double sampling (CDS) technique by reading a reset voltage signal from each pixel of the pixel array unit 10 and a data voltage signal, and then outputting a difference between these two voltage signals. However, in case that a level of the reset voltage signal outputted from each pixel of the pixel array unit 10 is not maintained within a proper range, the image appears distorted even if the CDS technique is used.

In other words, there occurs the distortion wherein the image of an extremely bright object as like the sun is expressed in black.

To solve this problem, in the conventional image sensor, a user directly controls a clamping voltage from outside of the image sensor to be accorded with an external environment so that the reset voltage signal dose not decrease below the clamping voltage.

However, the method is disadvantageous because the clamping voltage value should be set properly with reference to distributions the reset voltage signal whenever the external environment using the image sensor changes. Even if there is no change in the external environment, the user should externally control the clamping voltage since the image sensor has different operational characteristics due to changes occurring in the course of the image sensor fabrication process.

### SUMMARY OF THE INVENTION

It is, therefore, an object of the present invention to provide an image sensor with an improved automatic control of a reset voltage so that the image sensor itself automatically controls a proper clamping voltage in accordance with changes in external environments and processes and a control method thereof.

In accordance with an aspect of the present invention, there is provided an image sensor, including: An image sensor, comprising: a pixel array unit including a plurality of pixels for detecting optical information inputted from an external environment; an analog line buffer unit that detects and stores voltages of the plurality of pixels in a selected row; and an automatic reset voltage clamping unit for adjusting a clamping voltage value in response to a reset voltage distribution of a pixel output before storing the outputted value from the pixel array unit.

In accordance with another aspect of the present invention, there is also provided a method for controlling a reset voltage of an image sensor, comprising the steps of: comparing a reset voltage signal transmitted from a pixel to a present clamping voltage, a maximum clamping voltage and a minimum clamping voltage and outputting a signal of a first level or a second level; counting the signals of the first level and the second level; and comparing the counting results with respect to one frame with each other and adjusting the clamping voltage.

The present invention provides an image sensor that automatically controls a clamping voltage with reference to distributions of a reset voltage in accordance with changes in external environments and processes so as to obtain an image without distortion. In more detail of the automatic control, a reset voltage signal outputted from each pixel and a reference voltage are compared to each other through a comparator. After the comparison, the outputted comparative values are counted, and a range of the appropriate clamping voltage is automatically controlled for each frame based on the result of the counting procedure. Also, the reference voltage is set with an arbitrary value ranging between the maximum clamping voltage and the minimum clamping voltage.

### BRIEF DESCRIPTION OF THE DRAWING (S)

The above and other objects and features of the present invention will become apparent from the following description of the preferred embodiments given in conjunction with the accompanying drawings, in which:

FIG. 1 is a block diagram showing an image sensor in accordance with a prior art;

FIG. 2 is a block diagram showing an image sensor in accordance with the present invention;

FIG. 3A and FIG. 3B are conceptual diagrams illustrating a control of a clamping voltage;

FIG. 4 is a conceptual diagram illustrating an automatic reset voltage clamping function in accordance with the present invention;

FIG. 5 is a detailed block diagram illustrating an automatic reset voltage clamping unit of FIG. 2; and

FIG. 6 is a detailed circuit diagram illustrating a clamping voltage comparator of FIG. 5.

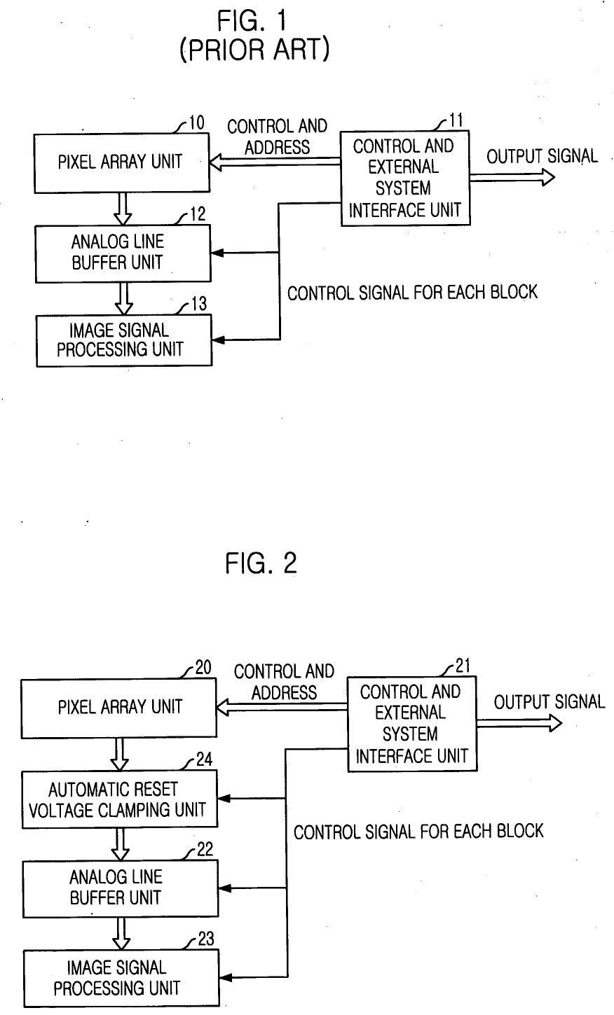

### DETAILED DESCRIPTION OF THE INVENTION

FIG. 2 is a block diagram illustrating an image sensor in accordance with the present invention.

Referring to FIG. 2, the image sensor includes a pixel array unit 20 for detecting an optical image from an external environment, a control and external system interface unit 21, an analog line buffer unit 22 that detects and stores voltages of pixels in a selected row, an image signal processing unit 23, and an automatic reset voltage clamping unit 24 that controls a clamping voltage in response to a reset voltage distribution of a pixel output before storing an outputted value from the pixel array unit 20 to the analog line buffer 22.

Hereinafter, operations of constitutional elements will be described in more detail.

The pixel array unit 20 arrays horizontally N numbers of pixels and vertically M number of pixels, where N and M are integers, in order to maximize reactivity to light. The pixel array unit 20 is an essential element of the whole image sensor by detecting information related to images from an external environment. The control and external system interface unit 21 controls an overall operation of the image sensor with use of a finite state machine (FSM) and enacts as an interface to the external system. Also, the control and external system interface unit 21 has a batch register (not shown), and thus, is able to program data related to various internal operations and controls operations of a whole chip based on the programmed information.

The analog line buffer unit 22 detects and stores voltages of pixels in a selected row, and includes various lines to be employed for color interpolation used at a rear end and an image signal processing. The image signal processing unit 23 performs additional diverse functions in accordance with functions of the image sensor so to enhance a sensor function of the image sensor based on the outputted values of the pixels stored in the analog line buffer 22. The stored outputted values of the pixels are color interpolation, color correction, gamma correction, auto while balance, auto exposure and so forth.

Also, the automatic reset voltage clamping unit 24 outputs a clamping voltage value appropriately in accordance with the reset voltage distribution of the pixel output before storing the outputted value from the pixel array unit 20 to the analog line buffer unit 22. Through this adjustment of the clamping voltage, the automatic reset voltage clamping unit 24 can controls a range of the clamping voltage.

As a reference, a typical image sensor generally employs a correlated double sampling (CDS) technique to eliminate fixed pattern noises occurring due to a process or a path that is not preferable. The CDS technique becomes effective when the reset voltage distribution has a narrow width and is in a precedent position among fields of pixel output signals.

However, in case of receiving optical information about an extremely bright object such as the sun from an external environment, there is a minimal difference between the reset voltage signal of the pixel output and a data voltage signal, resulting in a distorted image generated through the CDS technique. Therefore, when the reset voltage distribution is extensively low, the reset voltage value should be maintained within an appropriate level so as to eliminate the distortion of the image for obtaining a good image.

For this reason, in the typical image sensor, a user oneself sets directly the clamping voltage value in accordance with changes in an external environment to control the reset voltage signal value in an appropriate level.

However, this typical image sensor is unable to control the clamping voltage value with respect to unexpected changes or in the external environment. Hence, the user of the typical image sensor should always correct the clamping voltage value. However, if the clamping voltage value that controls the reset voltage signal is not in the appropriate level, offset phenomenon may be further induced by another CDS technique.

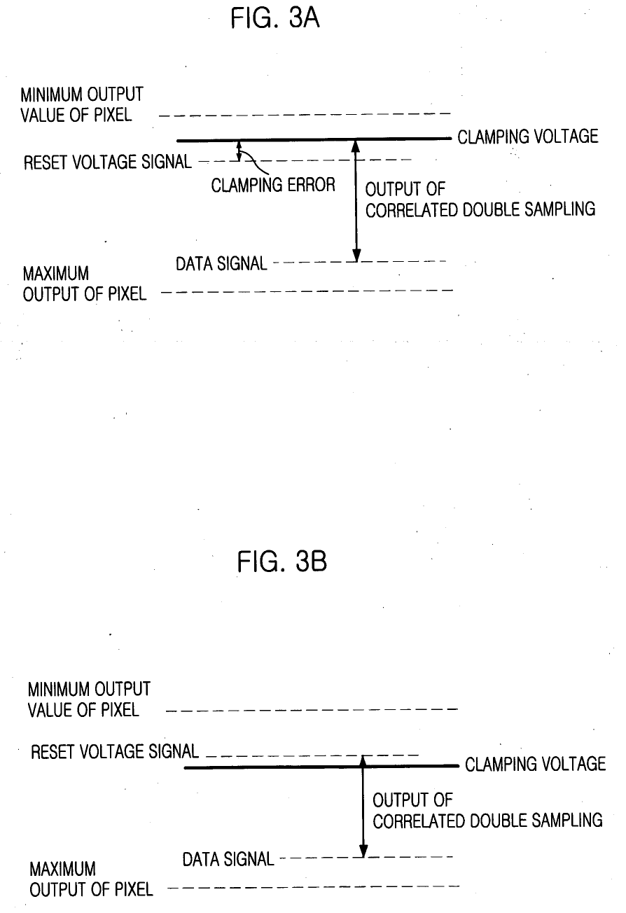

FIG. 3A and FIG. 3B are conceptual diagrams illustrating a control of a clamping voltage. As shown in FIG. 3A, in case that the reset voltage signal is below of the clamping voltage, the value obtained through the CDS technique is not a substitution of the data voltage signal from the reset voltage signal but from the clamping voltage. Therefore, there occurs an error as much as a clamping error, and this error becomes a cause of the image distortion. This error is expressed in FIG. 3B.

With reference to FIG. 3B, the image sensor in accordance with the present invention automatically lowers the clamping voltage value below the reset voltage to correct the CDS technique is a substitution of the data voltage from the reset voltage.

To complement the above-mentioned error, the image sensor provided from the present invention is improved with an additional automatic reset voltage clamping function that allows the image sensor to automatically adjust the clamping voltage. The following will describe operations of the automatic reset voltage clamping function in considerable details.

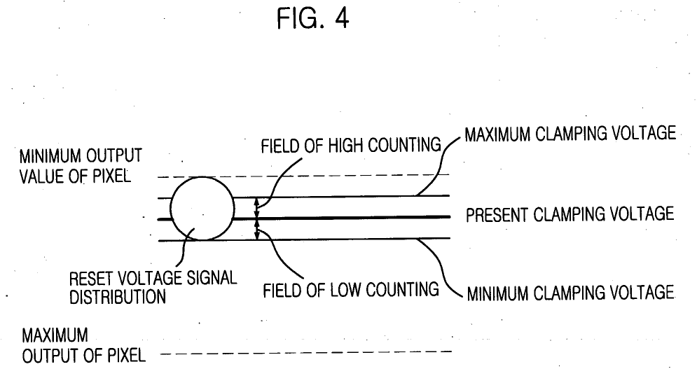

FIG. 4 is a conceptual diagram illustrating the automatic reset voltage clamping function in accordance with the present invention. As illustrated in FIG. 4, a present clamping voltage value, a maximum clamping voltage and a minimum voltage value are set and compared to the reset voltage signal value of the pixel output.

Referring to FIG. 4, each number of a field of which reset voltage value is higher than the present clamping voltage but lower than the maximum clamping voltage and a field of which reset voltage value is lower than the present clamping voltage but higher than the minimum clamping voltage is counted and compared the results with each other so as to automatically control the clamping voltage value for each frame.

Since the above correction process can be automatically proceeded for each frame, it is possible to control impacts from changes in external environments and problems in the image sensor fabrication process.

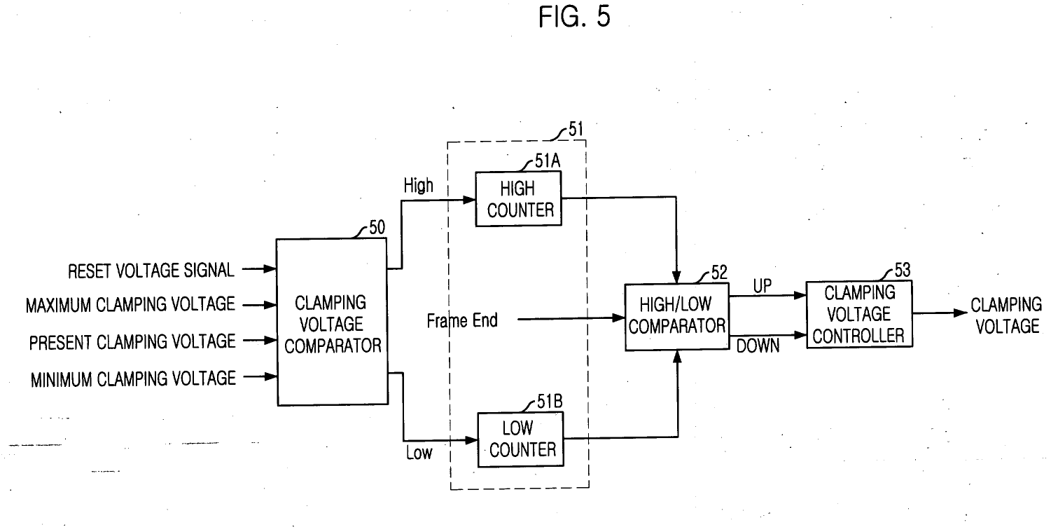

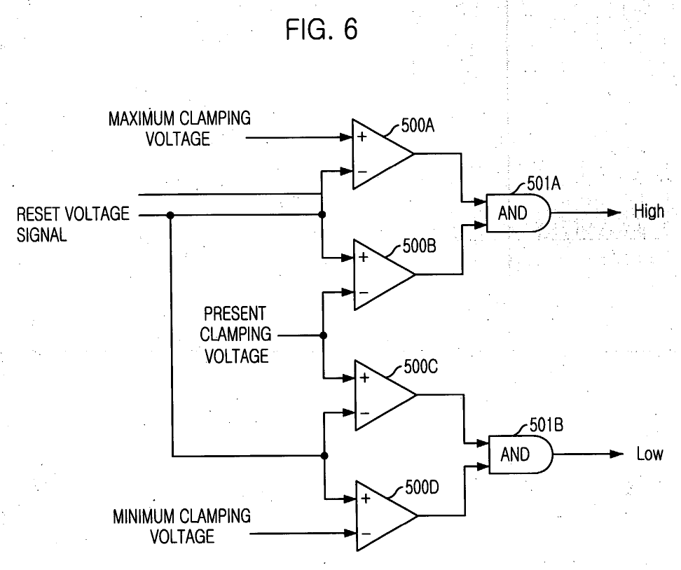

FIG. 5 is a detailed block diagram showing an automatic reset voltage clamping unit of FIG. 2, and FIG. 6 is a detailed circuit diagram showing a clamping voltage comparator of FIG. 5.

Referring to FIG. 5, the automatic reset voltage clamping unit 24 includes a clamping voltage comparator that compares the reset voltage signal transmitted from the pixel to the present clamping voltage, the maximum clamping voltage and the minimum clamping voltage, a counter 51 that counts sequentially a first level and a second level, e.g., a high level and a low level, based on the comparison through the clamping voltage comparator 50, a level comparator 52 that generates an up/down signal in accordance with the counting results once the operation per one frame is completed and a clamping voltage controller 53 that outputs a adjusted clamping voltage in accordance with the up/down signal.

With reference to FIG. 6, the clamping voltage comparator 50 includes a first comparator 500A that takes the maximum clamping voltage as a main input and the reset voltage signal as a supplementary input, a second comparator 500B that takes the reset voltage signal as a main input and the present clamping signal as a supplementary voltage, a third comparator 500C that takes the present clamping input as a main input and the reset voltage signal as a supplementary input, a forth comparator 500D that takes the reset voltage signal as a main input and the minimum clamping signal as a supplementary input, a first logic AND gate 501A that performs a logic AND of outputs from the first comparator 500A and the second comparator 500B and outputs a first level signal, e.g., “high” and a second logic AND gate 501B that performs a logic AND of outputs from the third comparator 500C and the forth comparator 500D and outputs a second level signal, e.g., “low”.

The following will describe the automatic reset voltage clamping function in accordance with the present invention.

Firstly, the reset voltage signal transmitted from the pixel is compared to the present clamping voltage, the maximum clamping voltage and the minimum clamping voltage through the clamping voltage comparator 50, and then, a value of the counter 51, i.e., a high counter 51A and a low counter 51B that satisfies a set condition is increased. For instance, if the reset voltage signal is higher-than the present clamping voltage but lower than the maximum clamping voltage, a value from the high counter is increased, while a value from the low counter is increased if the reset voltage signal is lower than the present clamping voltage but higher than the minimum clamping voltage. Once one cycle of the frame is finished, a signal of ‘frame end’ is generated, and all the counted values for one cycle of the frame are compared to each other to generate an up signal or a down signal based on the result from the comparison. In case that there is no up/down signal, the clamping voltage value is not adjusted since the value of the clamping voltage is appropriately within a range of the reset voltage signal distribution. Rather, an adjustment range of the clamping voltage value is repetitively set and maintained within a narrow range to avoid a sudden change between frames.

In case that the reset voltage signal value of the image sensor changes without any restriction with respect to an external environment, this change affects disadvantageously noises that occurs in a form of strips on the screen, a contrast distribution and colors. Even if the external environment is not changed, problems in the image sensor fabrication process result in various forms of image distortion. Therefore, the image sensor in accordance with the present invention controls the clamping voltage value in accordance with the reset voltage signal distribution of the pixel, and sets a limited range of the reset voltage value. As a result of the limitation, it is possible to eliminate a decrease in a quality of the image occurring when there are problems in the image sensor fabrication process or sudden changes in external environments.

That is, the preferred embodiment of the present invention provides an ultimate effect of improving the quality of the image due to the elimination of a factor that decreases the quality of the image because of the problems in the image sensor fabrication process and the sudden changes in external environments.

While the present invention has been described with respect to certain preferred embodiments, it will be apparent to those skilled in the art that various changes and modifications may be made without departing from the scope of the invention as defined in the following claims.

What is claimed is:

1. An image sensor, comprising:
a pixel array unit including a plurality of pixels for detecting optical information inputted from an external environment;
an analog line buffer unit that detects and stores voltages of the plurality of pixels in a selected row; and
an automatic reset voltage clamping unit for adjusting a clamping voltage value in response to a reset voltage distribution of a pixel output before storing the outputted value from the pixel array unit.

2. The image sensor as recited in claim 1, wherein the automatic reset voltage clamping unit further includes:
a clamping voltage comparator that compares a reset voltage signal transmitted from the pixel to a present clamping voltage, a maximum clamping voltage, and a minimum clamping voltage and outputs a first level signal or a second level signal;
a first and a second counters that count each signal from the first level and the second level signal;
a level comparator that generates an up signal or a down signal based on the counting result once an operation for one frame is completed; and
a clamping voltage controller that outputs the clamping voltage adjusted in accordance with the up or down signal.

3. The image sensor as recited in claim 2, wherein the automatic reset voltage clamping unit increases the value of the first counter in case that a voltage value of the reset voltage signal is higher than the present clamping voltage but lower than the maximum clamping voltage, and increases the value of the second counter in case that a value of the reset voltage signal is lower than the present clamping voltage but higher than the minimum clamping voltage.

4. The image sensor as recited in claim 2, wherein the value of the clamping voltage is not adjusted in case that there is no up and down signal.

5. The image sensor as recited in claim 2, wherein the clamping voltage comparator includes:
a first comparator taking the maximum clamping voltage as a main input and the reset voltage signal as a supplementary input;
a second comparator that takes the reset voltage signal as a main input and the present clamping voltage as a supplementary input;
a third comparator that takes the present clamping voltage as a main input and the reset voltage signal as a supplementary input;
a forth comparator that takes the reset clamping voltage as a main input and the minimum clamping voltage as a supplementary input;
a first logic AND gate that performs a logic AND of outputs from the first and the second comparators and outputs a signal from the first level; and
a second logic AND gate that performs a logic AND of outputs from the third and the forth comparators and outputs a signal from the second level.

6. A method for controlling a reset voltage of an image sensor, comprising the steps of:
comparing a reset voltage signal transmitted from a pixel to a present clamping voltage, a maximum clamping voltage and a minimum clamping voltage and outputting a signal of a first level or a second level;
counting the signals of the first level and the second level; and
comparing the counting results with respect to one frame with each other and adjusting the clamping voltage.

7. The method as recited in claim 6, wherein the step of comparing the reset voltage signal further includes the step of:
outputting the signal of the first level in case that the reset voltage signal is higher than the present clamping voltage but lower than the maximum clamping voltage; or
outputting the signal of the second level in case that the reset voltage signal is lower than the present clamping voltage but higher than the minimum clamping voltage.

8. The method as recited in claim 6, wherein the step of adjusting the clamping voltage includes further the step of:
outputting an up signal if the counting value for the signals of the first level is greater than that for the signals of the second level; or
outputting a down signal if the counting value for the signals of the second level is greater than that for the signals of the first level.

9. The method as recited in claim 8, wherein the clamping voltage value is not adjusted in case that there is no up and down signal.

10. The method as recited in claim 6, wherein an adjustment range of the clamping voltage value is repetitively set and controlled within a range that prevents a sudden change between frames.
